(19) United States
(12) Patent Application Publication
(10) Pub. No.: US 2008/0190367 A1
(43) Pub. Date: Aug. 14, 2008

(54) CHUCK ASSEMBLY AND HIGH DENSITY PLASMA EQUIPMENT HAVING THE SAME

(75) Inventors: Sang-Geun Lee, Seoul (KR); Min-Ho Choi, Gyeonggi-do (KR); Sung-Uk Park, Gyeonggi-do (KR); Jin-Sung Kim, Gyeonggi-do (KR); Jong-Suk Park, Seoul (KR); Dae-Hyun Kim, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 12/022,477

(22) Filed: Jan. 30, 2008

(30) Foreign Application Priority Data
Feb. 12, 2007 (KR) 10-2007-0014453

(51) Int. Cl. B05C 13/00

(52) U.S. Cl. 118/723 R; 118/500

(57) ABSTRACT

A chuck assembly for high density plasma equipment includes: a chuck having an upper surface and a plurality of pin holes formed in an outer peripheral portion, wherein the chuck upper surface is configured to receive a semiconductor substrate thereon; a substrate guide disposed on an outer surface of the chuck, wherein the substrate guide is configured to prevent a semiconductor substrate positioned on the upper surface of the chuck from being separated from the chuck; a fixing plate disposed at a lower portion of the chuck; a plurality of lift pins secured to the fixing plate and extending in an upward direction from the fixing plate so that each lift pin is inserted into a respective one of the pin holes, wherein each lift pin has an upper surface that extends to a position adjacent to the upper surface of the chuck; and a chuck lifter penetrating the fixing plate and engaged with a lower portion of the chuck, wherein the chuck lifter is configured to move the chuck upward and downward.

### CROSS-REFERENCE TO RELATED APPLICATION

This application claims priority from Korean Patent Application No. 10-2007-0014453, filed Feb. 12, 2007, the contents of which are hereby incorporated herein by reference in their entirety as if set forth fully herein.

### FIELD OF INVENTION

The present invention relates generally to semiconductor devices, and, more particularly, to apparatus for manufacturing semiconductor devices.

### BACKGROUND

In general, a semiconductor device manufacturing process includes a process of depositing a material film such as an insulating film, a semiconductor film, and a conductive film on a semiconductor substrate and the material film is formed using chemical vapor deposition equipment.

As semiconductor devices are becoming highly integrated, technologies such as the trench isolation process are becoming widely used. The essential technology of the trench isolation process includes forming a narrow and deep trench region by etching a predetermined region of a semiconductor substrate and filling the trench region with an insulating film having an excellent step coverage.

In recent years, a high density plasma oxide film has been widely used as an insulating film for filing a recessed region such as a trench region. A process of forming the high density plasma oxide film is realized by alternately and repeatedly performing a deposition process and an etching process. As a result, the trench region is filled with the high density plasma oxide film without a void and insulates semiconductor device elements with excellent characteristics.

Generally, high density plasma equipment forming a high density plasma oxide film includes a chamber, a plasma production unit for producing plasma inside the chamber, gas supply lines for sequentially supplying various kinds of gases into the interior of the chamber, a chuck installed in the interior of the chamber, for holding a semiconductor substrate, a plurality of lift pins respectively disposed in the interiors of pin holes formed in the chuck, the lift pins moving upward to an upper portion of the chuck and then moving downward into the interior of the chuck to position the semiconductor substrate transferred from outside on the upper surface of the chuck.

Therefore, the semiconductor substrate transferred from outside is positioned on the upper surface of the chuck by the plurality of lift pins. Various kinds of gases are sequentially supplied into the interior of the chamber and plasma is produced in the interior of the chamber to alternately and repeatedly perform deposition and etching processes. Accordingly, a high density plasma oxide film is formed on the semiconductor substrate.

When the above-mentioned process is performed, the plasma is produced not only on the upper side of the semiconductor substrate but also at an edge portion of the backside of the semiconductor substrate, which does not make contact with the chuck so that a film of the back side of the semiconductor substrate is damaged. More particularly, since an upper portion of the lift pin of the conventional high density plasma equipment, i.e. a portion of the pin hole formed in the chuck to move the lift pin upward, forms a large interval between the upper surface of the chuck and the upper surface of the lift pin and an opened region of the edge portion of the backside of the semiconductor substrate is very wide as compared with the other edge portions of the backside of the semiconductor substrate, the plasma is also produced at an upper portion of the lift pin so that the film of the backside of the semiconductor substrate may be damaged.

As a result, when a diffusion process is continuously performed after the process of forming the high density plasma oxide film, the film at the portion of the semiconductor substrate, which has been previously damaged, comes to be further damaged, thereby causing a rice defect.

### SUMMARY OF THE INVENTION

Therefore, the present invention is directed to a chuck assembly capable of reducing damage applied to a film of the backside of a wafer due to plasma during a high density plasma process, and to high density plasma equipment utilizing the chuck assembly.

In accordance with the first aspect of the present invention, there is provided a chuck assembly comprising: a chuck having an upper surface and a plurality of pin holes formed at an outer peripheral portion, wherein the chuck upper surface is configured to receive a semiconductor substrate thereon; a substrate guide disposed on an outer surface of the chuck, wherein the substrate guide is configured to prevent a semiconductor substrate positioned on the upper surface of the chuck from being separated from the chuck; a fixing plate disposed at a lower portion of the chuck; a plurality of lift pins secured to the fixing plate and extending in an upward direction from the fixing plate so that each lift pin is inserted into a respective one of the pin holes, wherein each lift pin has an upper surface that extends to a position adjacent to the upper surface of the chuck; and a chuck lifter penetrating the fixing plate and engaged with a lower portion of the chuck that moves the chuck upward and downward.

In some embodiments, the substrate guide may circumferentially surround the chuck.

In some embodiments, the pin holes may be formed between the substrate guide and the chuck.

In some embodiments, a gap between the upper surface of each lift pin and the upper surface of the chuck may be 0.2 to 0.5 mm.

In some embodiments, an outer surface of each lift pin is located adjacent to an inner surface of a corresponding pin hole when the center of the lift pin is located at the center of the corresponding pin hole. If the diameter of the pin hole is 4.8 mm, the diameter of the portion of the lift pin, which is inserted into the pin hole, may be 3.79 to 4.0 mm.

In some embodiments, the chuck may be an electrostatic chuck configured to hold a semiconductor substrate positioned on the upper surface of the chuck by electrostatic attraction.

In some embodiments, the chuck may include a positioning plate having an electrostatic electrode therein and a cooling plate disposed at a lower portion of the positioning plate.

In some embodiments, each lift pin may comprise a substrate support section configured to support a semiconductor substrate, a plate fixing section secured to the fixing plate, and a connection section extending between and connecting the substrate support section and the plate fixing section. The substrate support section has a first diameter, the connection section has a second diameter smaller than the first diameter, and the plate fixing section has a third diameter smaller than the second diameter.

In accordance with a second aspect of the present invention, there is provided a chuck assembly having an upper surface and a plurality of pin holes formed at an outer peripheral portion; a substrate guide disposed on an outer surface of the chuck, for preventing a semiconductor substrate positioned on the upper surface of the chuck from being separated from the chuck, wherein the substrate guide has a first upper surface located at a position higher than the upper surface of the chuck and a second upper surface disposed on an inner side of the first upper surface and located at a position lower than the upper surface of the chuck, so as to be stepped; a fixing plate disposed at a lower portion of the chuck; a plurality of lift pins secured to the fixing plate and extending in an upward direction from the fixing plate so that each lift pin is inserted into a respective one of the pin holes, wherein each lift pin has an upper surface located between the upper surface of the chuck and the second upper surface of the substrate guide; and a chuck lifter penetrating the fixing plate and engaged with a lower portion of the chuck that moves the chuck upward and downward.

In some embodiments, a gap between the upper surface of each lift pin and the upper surface of the chuck may be 0.2 to 0.5 mm. In accordance with a third aspect of the present invention, there is provided high density plasma equipment comprising: a chamber in which plasma is formed; a chuck installed inside the chamber and having an upper surface and a plurality of pin holes formed at an outer peripheral portion; a substrate guide disposed on an outer surface of the chuck, for preventing a semiconductor substrate positioned on the upper surface of the chuck from being separated from the chuck; a fixing plate disposed at a lower portion of the chuck and secured to the chamber; a plurality of lift pins secured to the fixing plate and extending in an upward direction from the fixing plate so that each lift pin is inserted into a respective one of the pin holes, wherein each lift pin has an upper surface that extends to a position adjacent to the upper surface of the chuck; and a chuck lifter penetrating the chamber and the fixing plate and engaged with a lower portion of the chuck that moves the chuck upward and downward.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a view showing an embodiment of high density plasma equipment according to the present invention;

FIG. 2 is a perspective view showing an embodiment of a chuck assembly used in the high density plasma equipment of FIG. 1;

FIG. 3 is a cross-sectional view of the chuck assembly which is taken along line I-I′ of FIG. 2;

FIGS. 4 and 5 are cross-sectional views for explaining a method for loading a semiconductor substrate using a chuck assembly according to the present invention;

FIG. 6 is an enlarged cross-sectional view showing a portion A of FIG. 5;

FIG. 7 is a plan view of the chuck assembly viewed from a direction B of FIG. 6;

FIG. 8 is a side sectional view showing an embodiment of a lift pin used in a chuck assembly according to the present invention;

FIG. 9 is a cross-sectional view showing the chuck assembly according to another embodiment of the present invention;

FIG. 10 is an enlarged cross-sectional view of a portion C of FIG. 9; and

FIG. 11 is a photograph showing an inspection of the backside of a semiconductor substrate after a high density plasma process is performed by regulating the interval between the upper surface of the chuck and the upper surfaces of the lift pins using the high density plasma equipment according to the present invention and then a following diffusion process is performed.

### DETAILED DESCRIPTION OF THE INVENTION

The invention will be described more fully hereinafter with reference to the accompanying drawings, in which example embodiments of the invention are shown. This invention may, however, be embodied in many different forms and should not be construed as limited to the example embodiments set forth herein. Rather, the disclosed embodiments are provided so that this disclosure will be thorough and complete, and will fully convey the scope of the invention to those skilled in the art. In the drawings, the size and relative sizes of layers and regions may be exaggerated for clarity. Moreover, each embodiment described and illustrated herein includes its complementary conductivity type embodiment as well. Like numbers refer to like elements throughout.

It will be understood that when an element or layer is referred to as being “on”, “connected to” and/or “coupled to” another element or layer, it can be directly on, connected or coupled to the other element or layer or intervening elements or layers may be present. In contrast, when an element is referred to as being “directly on,” “directly connected to” and/or “directly coupled to” another element or layer, there are no intervening elements or layers present. As used herein, the term “and/or” may include any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms may be used to distinguish one element, component, region, layer and/or section from another region, layer and/or section. For example, a first element, component, region, layer and/or section discussed below could be termed a second element, component, region, layer and/or section without departing from the teachings of the present invention.

Spatially relative terms, such as “below”, “lower”, “above”, “upper” and the like, may be used herein for ease of description to describe an element and/or a feature's relationship to another element(s) and/or feature(s) as illustrated in the figures. It will be understood that the spatially relative terms are intended to encompass different orientations of the device in use or operation in addition to the orientation depicted in the figures. For example, if the device in the figures is turned over, elements described as “below” other elements or features would then be oriented “above” the other elements or features. Thus, the example term “below” can encompass both an orientation of above and below. The device may be otherwise oriented (rotated 90° or at other orientations) and the spatially relative descriptors used herein interpreted accordingly. Moreover, the term “beneath” indicates a relationship of one layer or region to another layer or region relative to the substrate, as illustrated in the figures.

The terminology used herein is for the purpose of describing particular embodiments only and is not intended to be limiting of the invention. As used herein, the singular terms “a”, “an” and “the” are intended to include the plural forms as well, unless the context clearly indicates otherwise. It will be further understood that the terms “comprises,” “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof.

Example embodiments of the invention are described herein with reference to plan and cross-section illustrations that are schematic illustrations of idealized embodiments (and intermediate structures) of the invention. As such, variations from the shapes of the illustrations as a result, for example, of manufacturing techniques and/or tolerances, may be expected. Thus, the disclosed example embodiments of the invention should not be construed as limited to the particular shapes of regions illustrated herein unless expressly so defined herein, but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention, unless expressly so defined herein.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

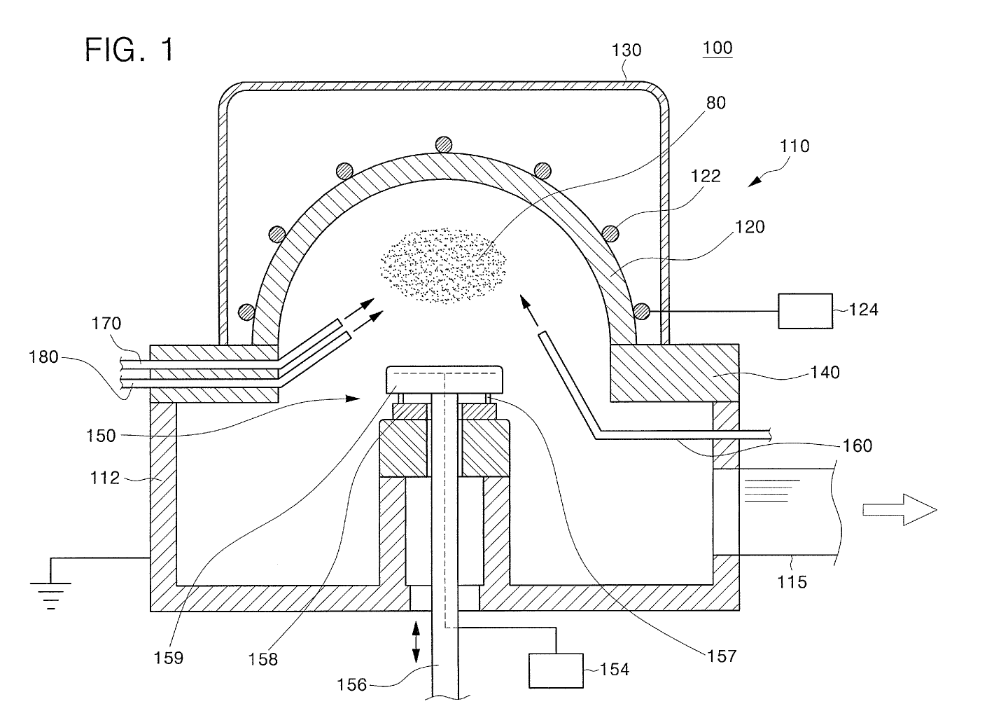

FIG. 1 is a view showing an embodiment of high density plasma equipment 100 according to some embodiments of the present invention.

Referring to FIG. 1, the high density plasma equipment 100 according to the illustrated embodiment of the present invention includes a chamber 110 in which plasma is formed to perform a process. The chamber 110 includes a chamber body 112 having an opened upper portion, a chamber lid 120 engaged with an upper portion of the chamber body 112 to close the chamber body 112, and a connection member 140 interposed between the chamber body 112 and the chamber lid 120.

A chuck assembly 150 configured to hold a semiconductor substrate (not shown) when a process is performed is installed at a central portion of the chamber body 112. A vacuum pumping line 115 configured to pump reaction by-products from the interior of the chamber 120 or gas to the outside is installed at a peripheral portion of the chamber body 112. A cleaning gas supply line 160 configured to supply cleaning gas into the interior of the chamber body 112 is installed at a peripheral portion of the chamber body 112.

The chamber lid 120 is dome-shaped and has a plasma forming space in which plasma is formed in the interior thereof. Further, a coil 122 for producing plasma in the chamber lid 120 is installed at an outer portion of the chamber lid 120. The coil 122 is connected to a plasma power source 124 and is configured to apply a predetermined electric power to the coil 122 to produce plasma. A chamber cover 130 is installed on the outer side of the chamber lid 120. The chamber cover 130 covers the coil 122 installed at an outer portion of the chamber lid 120 to protect the coil 122.

The connection member 140 is interposed between the chamber body 112 and the chamber lid 120 to connect the chamber body 112 and the chamber lid 120. The connection member 140 may be an insulating body that is configured to insulate the chamber body 112 and the chamber lid 120. Gas supply lines 170 and 180 that are configured to supply various process gases into the chamber body 112 may be installed in the connection member 140, as illustrated.

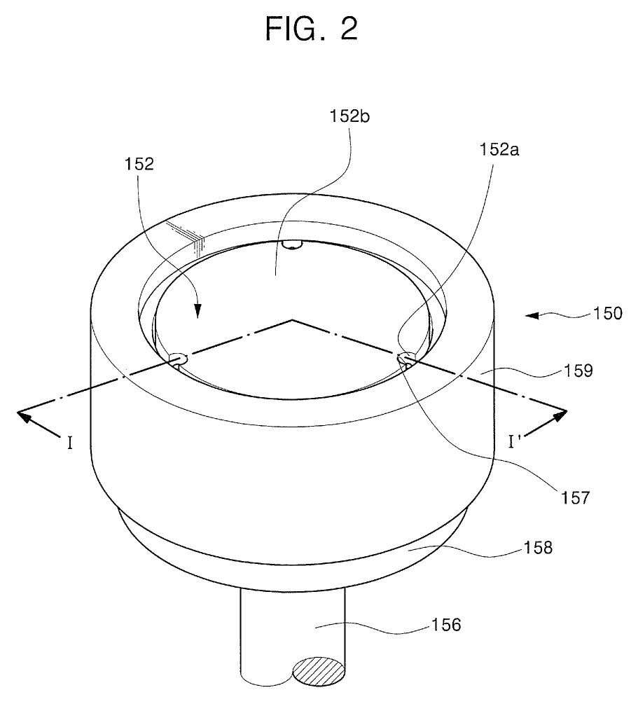

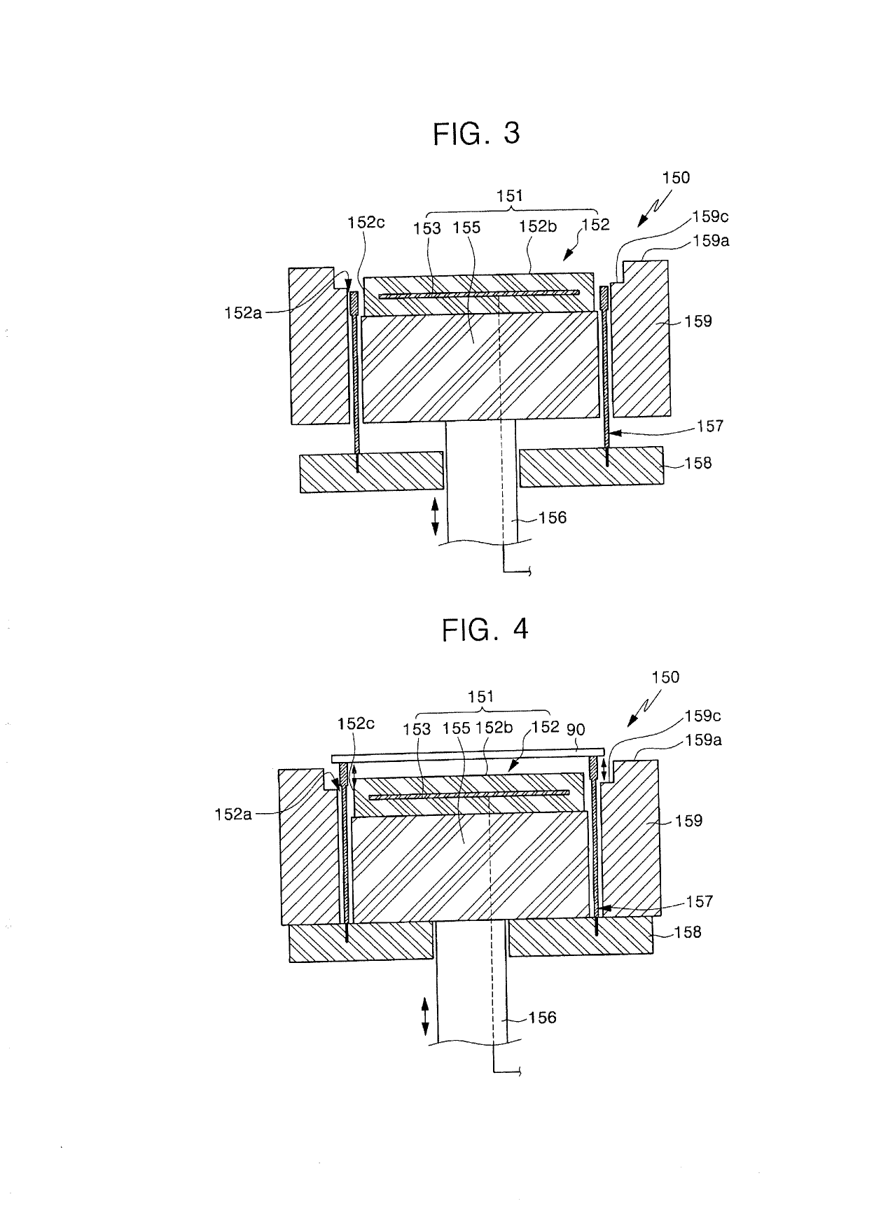

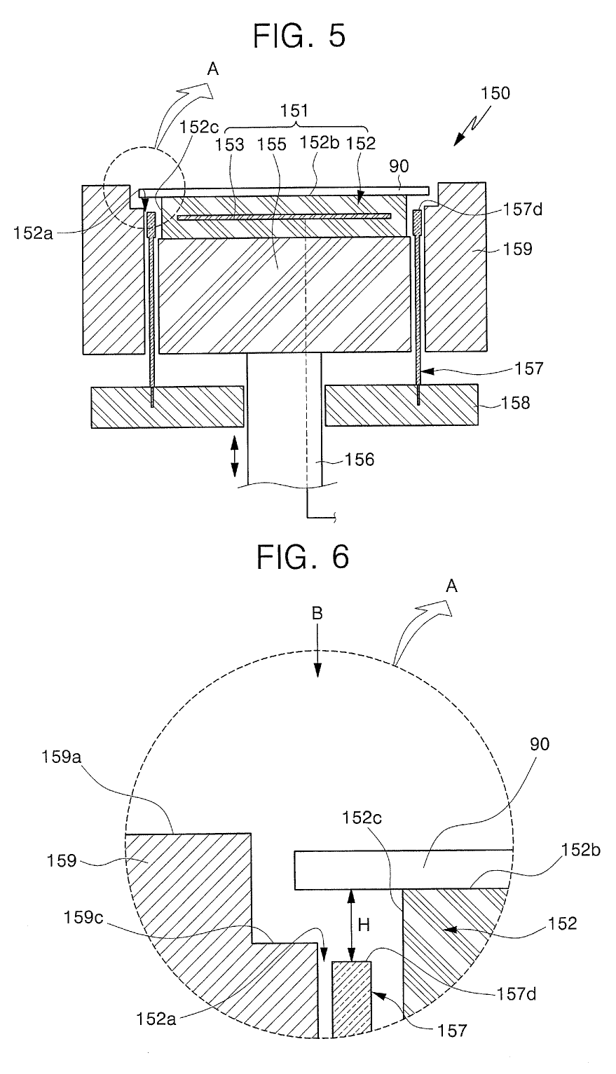

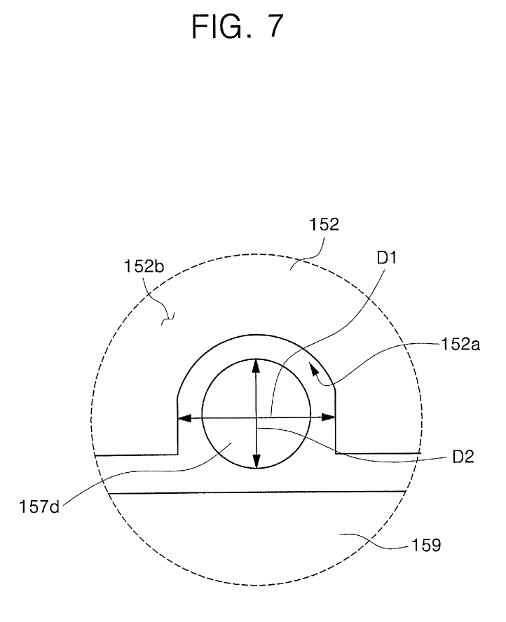

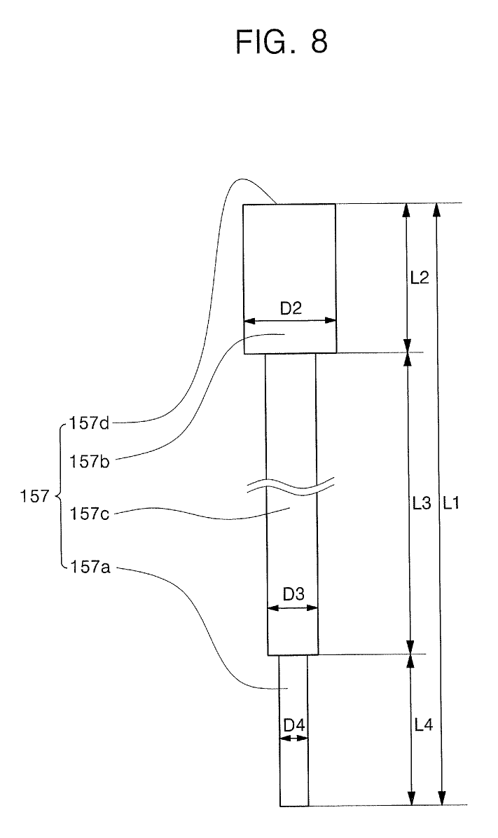

FIG. 2 is a perspective view showing of a chuck assembly used in the high density plasma equipment of FIG. 1, according to an embodiment of the present invention. FIG. 3 is a cross-sectional view of the chuck assembly which is taken long line I-I′ of FIG. 2. FIGS. 4 and 5 are cross-sectional views for explaining a method for loading a semiconductor substrate using a chuck assembly according to embodiments of the present invention. FIG. 6 is an enlarged cross-sectional view showing a portion A of FIG. 5. FIG. 7 is a plan view of the chuck assembly viewed from a direction B of FIG. 6. FIG. 8 is a side sectional view showing an embodiment of a lift pin used in a chuck assembly according to the present invention.

Referring to FIG. 1 to 8, a chuck assembly 150 according to an embodiment of the present invention includes a chuck 151 disposed in the interior of the chamber body 112, in which a semiconductor substrate 90 (FIG. 4) is positioned on the upper surface thereof. A plurality of pin holes 152a are formed at an outer peripheral portion of a positioning plate 152. A substrate guide 159 is disposed on the outer surface of the chuck 151. A fixing plate 158 is disposed at a lower portion of the chuck 151. Lift pins 157 are fixed to the fixing plate 158 and are installed in the upward direction of the fixing plate 158 so that each of the lift pins 157 can be inserted into a corresponding pin hole 152a. A chuck lifter 156 penetrates the chamber body 112 and the fixing plate 158 and engages with a lower portion of the chuck 151.

The chuck 151 may be an electrostatic chuck holding a semiconductor substrate 90 positioned on the chuck 151 by an electrostatic attraction. In one embodiment of the present invention, the chuck 151 includes a disc-shaped positioning plate 152 having an electrostatic electrode 153 installed in the interior thereof and a cooling plate 155, disc-shaped like the positioning plate 152, and disposed at a lower portion of the positioning plate 152. The diameter of the cooling plate 155 may be rather greater than that of the positioning plate 152. In this case, the cooling plate 155 may be engaged with the substrate guide 159 which will be described later and the positioning plate 152 may be separated from the substrate guide 159 by a predetermined interval.

Further, the electrostatic electrode 153 is connected to an electrostatic power source 154 (FIG. 1) that is configured to apply a predetermined amount of electric power to the electrostatic electrode 153 to produce an electrostatic attraction between the positioning plate 152 and a semiconductor substrate 90. The positioning plate 152 is formed of a dielectric material so as to produce an electrostatic attraction between the positioning plate 152 and a semiconductor substrate 90 when a predetermined electric power is applied to the electrostatic electrode 153. For example, the positioning plate 152 may be formed of Al₂O₃. The cooling plate 155 cools a semiconductor substrate 90 positioned on the positioning plate 152 and is formed of a material having an excellent thermal conductivity. For example, the cooling plate 155 may be formed of copper (Cu).

The substrate guide 159 is disposed on the outer surface of the chuck 151 so as to circumferentially surround the chuck 151 as illustrated, and prevents a semiconductor substrate 90 positioned on the upper surface of the chuck 151 from being separated from the chuck 151. The substrate guide 159 may have a shape capable of surrounding the chuck 151, i.e. a ring shape. Further, the illustrated substrate guide 159 has a first upper surface 159a located at a position rather higher than the upper surface 152b of the chuck 151. Substrate guide 159 also has a second upper surface 159c disposed on the inner side of the first upper surface 159a and located at a position lower than the upper surface 152b of the chuck 151, so as to be stepped. Then, the second upper surface 159c may be formed at a position lower than the upper surface 152b of the chuck 151 by approximately 0.15 to 0.45 mm.

On the other hand, the pin holes 152a formed at an outer peripheral portion of the chuck 151 may be formed between the substrate guide 159 and the chuck 151 and may be separated radially from the center of the chuck 151 by a uniform distance. That is, the pin holes 152a may be formed at the same radial distance (circumference) from the center of the chuck 151.

The fixing plate 158 is disposed on the lower side of the chuck 151 and is fixed to the chamber body 112. The fixing plate 158 may have a disc shape.

Each lift pin 157 is secured to the fixing plate 158 and extends in an upward direction from the fixing plate 158, as illustrated. The upper surface 157d of each lift pin 157 extends to a position adjacent to the upper surface 152b of the chuck 151, i.e. a position very close to the upper surface 152b of the chuck 151 and lower than the upper surface 152b of the chuck 151. In an embodiment of the present invention, the upper surface 157d of the lift pin 157 may extend to a position equal to or higher than the second upper surface 159c of the substrate guide 159, i.e. a position at which the interval or gap H (FIG. 6) between the upper surface 157d of the lift pin 157 and the upper surface 152b of the chuck 151 is approximately 0.2 to 0.5 mm.

Further, as shown in FIG. 8, each lift pin 157 may be multi-stepped. That is, each lift pin 157 may include a substrate support section 157b configured to support a semiconductor substrate 90, a plate fixing section 157a disposed at a lower portion of the semiconductor support section 157b and fixed to the fixing plate 158, and a connection section 157c connecting the substrate support section 157b and the plate fixing section 157a. The diameter of each lift pin 157 may become gradually smaller as illustrated in FIG. 8. For example, the diameter D2 of the substrate support section 157b, the diameter D3 of the connection section 157c disposed at a lower portion of the substrate support section 157b, and the diameter D4 of the plate fixing section 157a disposed at a lower portion of the connection section 157c may become gradually smaller, respectively (i.e., D2>D3>D4).

In some embodiments, the diameters D2 and D3 of the respective portions of the lift pins 157, which are inserted into the pin holes 152a, are selected such that the outer surfaces of the lift pins 157 are adjacent to the inner surfaces of the corresponding pin holes 152a when the centers of the lift pins 157 are located at the centers of the pin holes 152a. In one embodiment of the present invention, if the high density plasma equipment 100 is processing a semiconductor substrate 90 having a diameter of 200 mm, i.e. a wafer with a diameter of 200 mm and the diameter D1 of each pin hole 152a is approximately 4.8 mm, the diameters D2 and D3 of the portions of each lift pin 157, which are inserted into the pin hole 152a, may be approximately 3.79 to 4.0 mm.

In some embodiments, if the high density plasma equipment 100 is equipment processing a semiconductor substrate 90 having a diameter of 200 mm, i.e. a wafer with a diameter of 200 mm, the length L2 (FIG. 8) of the substrate support section 157b may be approximately 16 to 18 mm, the length L3 (FIG. 8) of the connection section 157c, approximately 48 to 52 mm, and the length L4 (FIG. 8) of the plate fixing section 157a, approximately 17.5 to 19.5 mm. That is, the entire length of each lift pin 157 may be approximately 83.5 to 87.5 mm.

The chuck lifter 156 penetrates the chamber body 112 and the fixing plate 158 and is engaged with a lower portion of the chuck 151. The chuck lifter 156 moves the chuck 151 upward and downward. In this case, since the lift pin 157 is fixed to the fixing plate 158, if the chuck 151 is moved downward by the chuck lifter 156, an upper end portion of the lift pin 157 protrudes to the upper side of the chuck 151. On the contrary, if the chuck 151 is moved upward by the chuck lifter 156, an upper end portion of the lift pin 157 enters the interior of the pin hole 152a formed in the chuck 151 as the chuck 151 is moved upward.

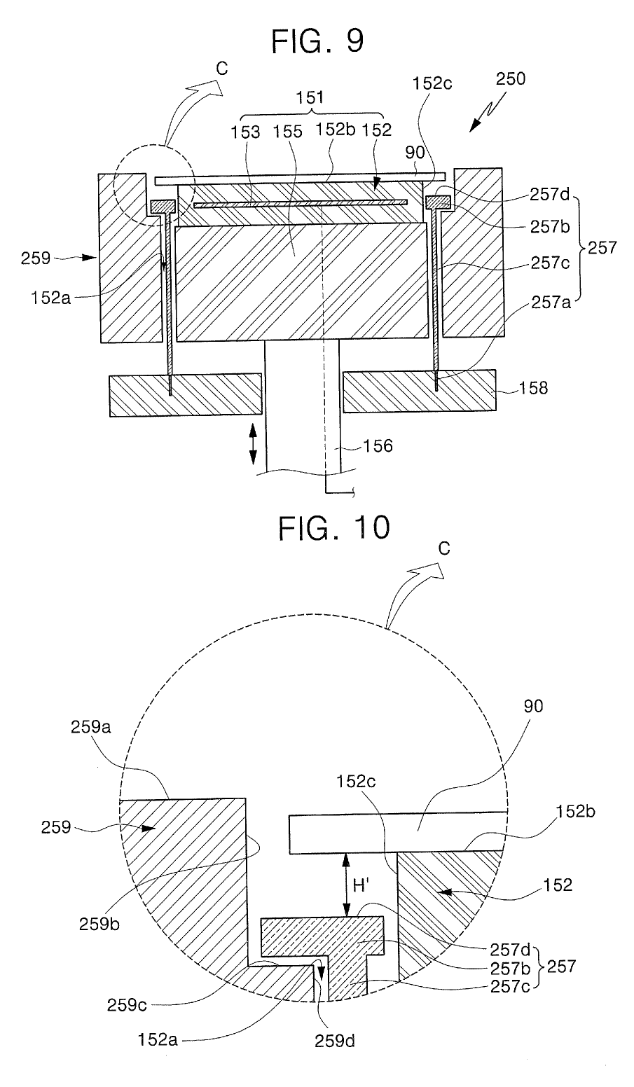

Another embodiment of a chuck assembly, according to some embodiments of the present invention, is shown in FIGS. 9 and 10.

FIG. 9 is a cross-sectional view showing a chuck assembly 250 according to another embodiment of the present invention. FIG. 10 is an enlarged cross-sectional view of a portion C of FIG. 9.

Referring to FIGS. 9 and 10, the illustrated chuck assembly 250 is similar the chuck assembly 150 illustrated in FIGS. 1-8. Therefore, hereinafter, parts different from the chuck assembly 150 according to the first mentioned embodiment will be mainly described in explanation of the chuck assembly 250 according to another embodiment of the present invention.

As shown in FIGS. 9 and 10, the illustrated chuck assembly 250 includes a chuck 151 disposed in the interior of the chamber body 112, in which a semiconductor substrate 90 is positioned on the upper surface thereof. A plurality of pin holes 152a are formed at an outer peripheral portion thereof. A substrate guide 259 is disposed on the outer surface of the chuck 151. A fixing plate 158 disposed at a lower portion of the chuck 151. Lift pins 257 are fixed to the fixing plate 158 and installed in the upward direction of the fixing plate 158, as illustrated, so that each of the lift pins 157 can be inserted into a corresponding pin hole 152a. A chuck lifter 156 penetrates the chamber body 112 and the fixing plate 158 and is engaged with a lower portion of the chuck 151.

The substrate guide 259 is disposed on the outer surface of the chuck 151 so as to surround the chuck 151, and prevents a semiconductor substrate 90 positioned on the upper surface of the chuck 151 from being separated from the chuck 151. The substrate guide 259 may have a shape capable of surrounding the chuck 151, i.e. a ring shape. Further, the substrate guide 259 has a first upper surface 259a located at a position higher than the upper surface 152b of the chuck 151 and a second upper surface 259c disposed on the inner side of the first upper surface 259a and located at a position lower than the upper surface 152b of the chuck 151, so as to be stepped. The second upper surface 259c may be formed at a position lower than the upper surface 152b of the chuck 151 by approximately 0.15 to 0.45 mm. The reference numeral 259b refers to a first inner surface connecting the first upper surface 259a and the second upper surface 259c and the reference numeral 259d refers to a second inner surface connected to the second upper surface 259c.

Each lift pin 257 is fixed to the fixing plate 158 and is installed in the upward direction of the fixing plate 158 so as to be inserted into a corresponding pin hole 152a. The upper surface 257d of each lift pin 257 is located at a position adjacent to the upper surface 152b of the chuck 151, i.e. between the upper surface 152b of the chuck 151 and the second upper surface 259c of the substrate guide 259. The upper surface 257d of each lift pin 257 may extend to a position at which the interval or gap H′ (FIG. 10) between the upper surface 257d of the lift pin 257 and the upper surface 152b of the chuck 151 is approximately 0.2 to 0.5 mm.

Further, as shown in the FIGS. 9 and 10, each lift pin 257 may be multi-stepped. That is, each lift pin 257 may include a substrate support section 257b configured to support the semiconductor substrate 90, a plate fixing section 257a disposed at a lower portion of the semiconductor support section 257b and fixed to the fixing plate 158, and a connection section 257c connecting the substrate support section 257b and the plate fixing section 257a. The diameter of each lift pin 257 may become gradually smaller as it goes from the upper side to the lower side. In other words, the diameter of the substrate support section 257b, the diameter of the connection section 257c disposed at a lower portion of the substrate support section 257b, and the diameter of the plate fixing section 257a disposed at a lower portion of the connection section 257c may become gradually smaller, respectively.

The substrate support section 257b of each lift pin 257 may be disposed between the first inner surface 259b of a pin hole 152a and the chuck 151 and the connection section 257c of each lift pin 257 may be disposed between the second inner surface 259d of a pin hole 152a and the chuck 151. The diameters of the substrate support section 257b and the connection section 257c may be determined such that the outer surface of a lift pin 257 is adjacent to the inner surface of a corresponding pin hole 152a when the center of the lift pin 257 is located at the center of the pin hole 152a.

Hereinafter, the operation and the effect of the high density plasma equipment 100 according to some embodiments of the present invention will be described with reference to FIGS. 1 to 8.

First, if a semiconductor substrate 90 is transferred from outside by a substrate transferring apparatus (not shown), the chuck lifter 156 moves downward the chuck 151 supported by the chuck lifter 156 by a predetermined distance. Then, since the lift pins 157 are disposed in the interiors of the pin holes 152a provided in the chuck 151 and the upper surfaces of the lift pins 157 are located adjacent to the upper surface 152b of the chuck 151, when the chuck 151 is moved down, the lift pins 157 protrude to the upper side of the chuck 151 by a predetermined height.

Thereafter, the substrate transferring apparatus loads the semiconductor substrate 90 on the upper surfaces 157d of the lift pins 157, which have protruded to the upper side of the chuck 151, by a predetermined height.

Next, the chuck lifter 156 moves downward the chuck 151 supported by the chuck lifter 151 by a predetermined height. Therefore, the lift pins 157, which have protruded to the upper side of the chuck 151 by a predetermined height, enters the interiors of the pin holes 152a provided in the chuck 151 as the chuck 151 is moved upward and returns to an originally installed position. That is, the upper surfaces 157d of the lift pins 157 returns to the position adjacent to the upper surface 152b of the chuck 151. Further, after the semiconductor substrate 90 loaded on the upper surface 157d of the lift pin 157 is positioned on the upper surface of the chuck 151, it is held on the upper surface of the chuck 151 by an electrostatic attraction of the chuck 151.

Thereafter, if the semiconductor substrate 90 is held on the upper surface of the chuck 151, various process gases are sequentially supplied into the interior of the chamber 110 and plasma is produced. Then, deposition and etching processes are repeatedly and alternately performed. Thus, a high density plasma oxide layer is formed on the semiconductor substrate 90.

When deposition and etching processes are performed, upper portions of the lift pins 157 in the high density plasma equipment 100, i.e. portions of the pin holes 152a formed in the chuck 151 to move the lift pins 157 upward and downward are formed so that a very narrow interval H (FIG. 6) can be formed between the upper surface 152b of the chuck 151 and the upper surfaces 157d of the lift pins 157. Therefore, when the above-mentioned processes are performed, since the plasma produced at an edge portion of the backside of the semiconductor substrate 90 is small in quantity, the damage applied to a film of the backside of the semiconductor substrate 90 by the plasma is reduced. As a result, even when a diffusion process is continuously performed after a high density plasma oxide layer forming process, a rice defect on the backside of the semiconductor substrate 90 is reduced or is not generated at all.

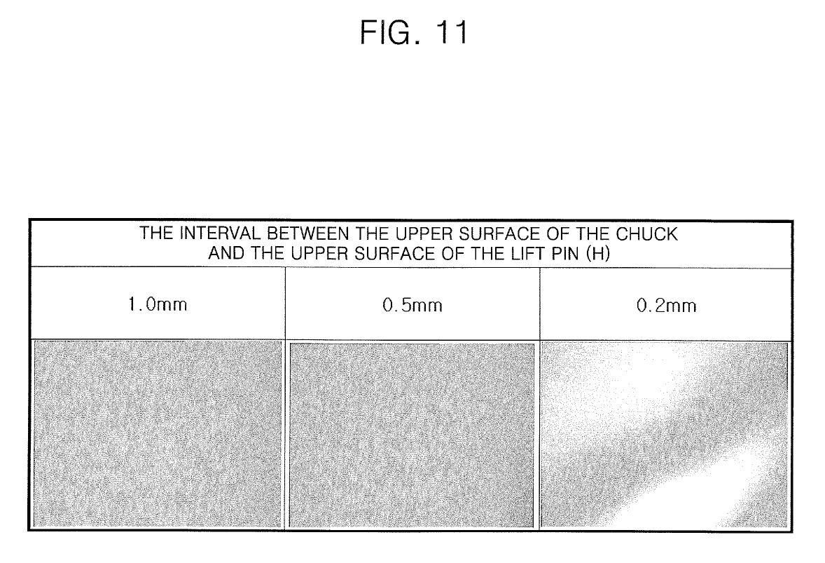

FIG. 11 is a photograph of an inspection of the backside of a semiconductor substrate after a high density plasma process is performed by regulating the interval between the upper surface of a chuck 151 and the upper surfaces 157d of the lift pins 157 using the high density plasma equipment according to embodiments of the present invention and then a following diffusion process is performed.

Referring to FIG. 11, it can be seen that when performing a deposition and etching process using the high density plasma equipment, if the gap H between the upper surface of the chuck 151 and the upper surfaces 157d of the lift pins 157 is approximately 0.2 to 0.5 mm, the rice detect in the film on the backside of the semiconductor substrate is reduced or is not generated at all. Consequently, if a deposition and etching process is performed using the high density plasma equipment of the present invention in which the upper surface of the chuck 151 and the upper surfaces 157d of the lift pins 157 are separated from each other by the gap of approximately 0.2 to 0.5 mm, the damage applied to the film on the backside of a semiconductor substrate can be prevented in advance.

According to some embodiments of the present invention, since upper portions of the lift pins in the high density plasma equipment, i.e. portions of the pin holes formed in the chuck to move the lift pins upward and downward are formed so that a very narrow interval can be formed between the upper surface of the chuck 151 and the upper surfaces 157d of the lift pins 157, the plasma produced at an edge portion of the backside of a semiconductor substrate 90 is very small in quantity. Therefore, the damage applied to a film of the backside of the semiconductor substrate 90 by the plasma is reduced.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A chuck assembly comprising:
a chuck having an upper surface and a plurality of pin holes formed in an outer peripheral portion, wherein the chuck upper surface is configured to receive a semiconductor substrate thereon;
a substrate guide disposed on an outer surface of the chuck, wherein the substrate guide is configured to prevent a semiconductor substrate positioned on the upper surface of the chuck from being separated from the chuck;
a fixing plate disposed at a lower portion of the chuck;
a plurality of lift pins secured to the fixing plate and extending in an upward direction from the fixing plate so that each lift pin is inserted into a respective one of the pin holes, wherein each lift pin has an upper surface that extends to a position adjacent to the upper surface of the chuck; and
a chuck lifter penetrating the fixing plate and engaged with a lower portion of the chuck, wherein the chuck lifter is configured to move the chuck upward and downward.

2. The chuck assembly according to claim 1, wherein the substrate guide circumferentially surrounds the chuck.

3. The chuck assembly according to claim 1, wherein the pin holes are formed between the substrate guide and the chuck.

4. The chuck assembly according to claim 1, wherein a gap between the upper surface of each lift pin and the upper surface of the chuck is 0.2 to 0.5 mm.

5. The chuck assembly according to claim 1, wherein an outer surface of each lift pin is located adjacent to an inner surface of a corresponding pin hole when the center of the lift pin is located at the center of the corresponding pin hole.

6. The chuck assembly according to claim 5, wherein a diameter of each pin hole is 4.8 mm, and a diameter of the portion of each lift pin inserted into the pin hole is 3.79 to 4.0 mm.

7. The chuck assembly according to claim 1, wherein the upper surface of the chuck is configured to hold a semiconductor substrate positioned there on by electrostatic attraction.

8. The chuck assembly according to claim 1, wherein the chuck comprises a positioning plate having an electrostatic electrode installed there inside and a cooling plate disposed at a lower portion of the positioning plate, and wherein each lift pin comprises:
a substrate support section configured to support a semiconductor substrate,
a plate fixing section secured to the fixing plate, and
a connection section extending between and connecting the substrate support section and the plate fixing section.

9. The chuck assembly according to claim 8, wherein the substrate support section has a first diameter, the connection section has a second diameter smaller than the first diameter, and the plate fixing section has a third diameter smaller than the second diameter.

10. A chuck assembly comprising:
a chuck having an upper surface and a plurality of pin holes formed in an outer peripheral portion, wherein the chuck upper surface is configured to receive a semiconductor substrate thereon;
a substrate guide disposed on an outer surface of the chuck, wherein the substrate guide is configured to prevent a semiconductor substrate positioned on the upper surface of the chuck from being separated from the chuck, wherein the substrate guide has a first upper surface located at a position higher than the upper surface of the chuck and a second upper surface disposed on an inner side of the first upper surface and located at a position lower than the upper surface of the chuck;
a fixing plate disposed at a lower portion of the chuck;
a plurality of lift pins secured to the fixing plate and extending in an upward direction from the fixing plate so that each lift pin is inserted into a respective one of the pin holes, wherein each lift pin has an upper surface located between the upper surface of the chuck and the second upper surface of the substrate guide; and
a chuck lifter penetrating the fixing plate and engaged with a lower portion of the chuck, wherein the chuck lifter is configured to move the chuck upward and downward.

11. The chuck assembly according to claim 10, wherein a gap between the upper surface of each lift pin and the upper surface of the chuck is 0.2 to 0.5 mm.

12. A high density plasma equipment comprising:
a chamber in which plasma is formed;
a chuck installed inside the chamber and having an upper surface and a plurality of pin holes formed in an outer peripheral portion, wherein the chuck upper surface is configured to receive a semiconductor substrate thereon;
a substrate guide disposed on an outer surface of the chuck, wherein the substrate guide is configured to prevent a semiconductor substrate positioned on the upper surface of the chuck from being separated from the chuck;
a fixing plate disposed at a lower portion of the chuck and secured to the chamber;
a plurality of lift pins secured to the fixing plate and extending in an upward direction from the fixing plate so that each lift pin is inserted into a respective one of the pin holes, wherein each lift pin has an upper surface that extends to a position adjacent to the upper surface of the chuck; and
a chuck lifter penetrating the chamber and the fixing plate and engaged with a lower portion of the chuck, wherein the chuck lifter is configured to move the chuck upward and downward.

13. The high density plasma equipment according to claim 12, wherein the substrate guide circumferentially surrounds the chuck.

14. The high density plasma equipment according to claim 12, wherein the pin holes are formed between the substrate guide and the chuck.

15. The high density plasma equipment according to claim 12, wherein a gap between the upper surface of each lift pin and the upper surface of the chuck is 0.2 to 0.5 mm.

16. The high density plasma equipment according to claim 12, wherein an outer surface of each lift pin is located adjacent to an inner surface of a corresponding pin hole when the center of the lift pin is located at the center of the corresponding pin hole.

17. The high density plasma equipment according to claim 16, wherein a diameter of each pin hole is 4.8 mm, and a diameter of the portion of each lift pin inserted into the pin hole is 3.79 to 4.0 mm.

18. The high density plasma equipment according to claim 12, wherein an upper surface of the chuck is configured to hold a semiconductor substrate positioned thereon by electrostatic attraction.

19. The high density plasma equipment according to claim 12, wherein the chuck comprises having an electrostatic electrode installed there inside and a cooling plate disposed at a lower portion of the positioning plate, and wherein each lift pin comprises:
a substrate support section configured to support a semiconductor substrate,
a plate fixing section second to the fixing plate, and
a connection section extending between and connecting the substrate support section and the plate fixing section.

20. The high density plasma equipment according to claim 19, wherein the substrate support section has a first diameter, the connection section has a second diameter smaller than the first diameter, and the plate fixing section has a third diameter smaller than the second diameter.
